(19) United States
(12) Patent Application Publication
(10) Pub. No.: US 2022/0126695 A1
(43) Pub. Date: Apr. 28, 2022

(54) APPARATUS AND METHOD FOR SUPPORTING SAFETY OF DRIVER

(71) Applicants: HYUNDAI MOTOR COMPANY, Seoul (KR); KIA CORPORATION, Seoul (KR)

(72) Inventors: Myoung Soo PARK, Yongin-si (KR); Woo Kuen KIM, Seoul (KR); Jin Gu KWON, Seoul (KR)

(73) Assignees: HYUNDAI MOTOR COMPANY, Seoul (KR); KIA CORPORATION, Seoul (KR)

(21) Appl. No.: 17/365,588

(22) Filed: Jul. 1, 2021

(30) Foreign Application Priority Data
Oct. 22, 2020 (KR) 10-2020-0137820

(51) Int. Cl. B60L 1/00; B60L 53/20; B60R 21/0132; B60Q 3/20; B60R 25/01; B60N 2/04

(52) U.S. Cl. CPC B60L 1/00; B60L 53/20; B60R 21/0132; B60L 2210/10; B60R 25/01; B60N 2/04; B60Q 3/20

(57) ABSTRACT

An apparatus and a method for supporting safety of a driver are provided. The apparatus for supporting the safety of the driver includes a sensor to sense collision of an electric vehicle, a voltage converter to convert down a high voltage of a high voltage battery, which is provided in the electric vehicle, to a low voltage and to supply the low voltage to a safety device, and a controller to activate the voltage converter in the state that power is not supplied to the safety device provided in the electric vehicle due to the collision, such that the driver is supported to be escaped from the electric vehicle while preparing for a secondary collision with the following vehicle, in the state that power is not supplied to various safety devices provided in the electric vehicle due to a car collision accident.

### CROSS-REFERENCE TO RELATED APPLICATION

This application claims priority to and the benefit of Korean Patent Application No. 10-2020-0137820, filed on Oct. 22, 2020, the entire contents of which are incorporated herein by reference.

### FIELD

The present disclosure relates to a technology of supporting the safety of a driver in the state that the collision accident of an electric vehicle occurs.

### BACKGROUND

The statements in this section merely provide background information related to the present disclosure and may not constitute prior art.

In general, an electric vehicle, which is traveling by driving an electric motor using a high voltage battery, may include a hybrid electric vehicle (HEV), an electric vehicle (EV), a plug-in hybrid electric vehicle (PHEV), or a fuel cell electric vehicle (FCEV).

The electric vehicle may include a high voltage battery to supply power for driving, a low voltage DC-DC converter to convert down a high voltage of the high voltage battery to a voltage for charging an auxiliary battery such that the auxiliary battery is charged, or to convert down the high voltage of the high voltage battery to a low voltage (for example, 12 V) to be supplied to an internal electric device (electronic part load) through a power manager, and an auxiliary battery to supply operating power to the internal electric device.

A typical power manager is equipped with a number of fuses, which prevent overcurrent or overload from being transmitted to an external circuit, or relays which open and close a power supply, such that battery power is supplied and distributed, and a wire is protected. In addition, the typical power manager may receive and protect various devices (fuses or relays) provided therein, and may rapidly radiate heat from the devices, such that an operating efficiency of the devices is maintained.

Recently, a smart power manager or an integrated central unit (ICU) has been introduced to supply a battery current to an electric load, to control the electric load, and to cut off the overcurrent, and to sense a load current by using a semiconductor switch in place of the relay or the fuse.

The ICU includes an intelligent power switch (IPS), which is a kind of a semiconductor switch device, and a micro control unit (MCU) to control the IPS, and controls power applied to the electric load through the IPS operating in response to a control signal of the MCU.

The IPS is significantly weak for electrical stress. Accordingly, when an electric short occurs, a progressive defect may be internally caused due to the electrical stress.

Meanwhile, when the collision accident of the electric vehicle occurs, as a power cable between the auxiliary battery and the power manager may be disconnected or shorted, power is not often supplied to the internal electric device. When the power supplied to the internal electric vehicle of the electric vehicle is cut off, secondary collision with a following vehicle may not be prepared (for example, an airbag may not be deployed, or an emergency lamp may not be turned on or off), and the escape of the driver may not be supported. Accordingly, the safety of the driver may not be supported.

Accordingly, there is required a scheme to support the operations of various safety devices provided in an electric vehicle (to supply power), in the situation that the power is not supplied to the internal electric device provided in the electric vehicle due to the collision accident.

The matter described in “BACKGROUND” is made for the convenience of explanation, and may include matters other than a related art well known to those skilled in the art.

### SUMMARY

The present disclosure has been made to solve the above-mentioned problems occurring in the prior art while advantages achieved by the prior art are maintained intact.

An aspect of the present disclosure is to provide an apparatus and a method for supporting safety of a driver, capable of controlling a low voltage DC-DC converter (LDC) to convert down a high voltage of a high voltage battery to a low voltage (for example, 12 V) and to supply the low voltage to a power manager, in the state that power is not supplied to various safety devices provided in an electric vehicle due to the collision accident, and of controlling an operation of the safety device, thereby supporting the escape of the driver while preparing for secondary collision with the following vehicle.

The technical problems to be solved by the present disclosed are not limited to the aforementioned problems, and any other technical problems not mentioned herein will be clearly understood from the following description by those skilled in the art to which the present disclosure pertains. In addition, it can be easily understood that the objects and the features of the present disclosure are realized by means and the combination of the means claimed in appended claims.

According to an aspect of the present disclosure, an apparatus for supporting safety of a driver may include a sensor to sense collision of an electric vehicle, a voltage converter to convert down a high voltage of a high voltage battery, which is provided in the electric vehicle, to a low voltage and to supply the low voltage to a safety device, and a controller to activate the voltage converter in the state that power is not supplied to the safety device provided in the electric vehicle due to the collision.

According to an exemplary form of the present disclosure, the controller may receive a signal for notifying power cut off from a power manager provided in the electric vehicle.

According to an exemplary form of the present disclosure, the safety device may include at least one of an airbag system, an emergency lamp system, a door system, an electric seat system, or an emergency call system.

According to an exemplary form of the present disclosure, the controller may control the emergency lamp system to turn on or turn off an emergency lamp provided in the electric vehicle.

According to an exemplary form of the present disclosure, the controller may control the door system to unlock a door provided in the electric vehicle.

According to an exemplary form of the present disclosure, the controller may control the electric seat system to move rearward an electric seat provided in the electric vehicle.

According to an exemplary form of the present disclosure, the controller may control the emergency call system to call an emergency rescue team.

According to an exemplary form of the present disclosure, the sensor may be a gravity acceleration sensor.

According to an exemplary form of the present disclosure, the voltage converter may be a low voltage DC-DC converter (LDC).

According to another aspect of the present disclosure, a method for supporting safety of a driver may include sensing, by a sensor, collision of an electric vehicle, activating, by a controller, a voltage converter in a state that power is not supplied to a safety device provided in the electric vehicle due to the collision, and converting down, by the voltage converter, a high voltage of a high voltage battery, which is provided in the electric vehicle, to a low voltage to supply the low voltage to the safety device.

According to an exemplary form of the present disclosure, the method may include receiving a signal for notifying power cut off from a power manager provided in the electric vehicle.

According to an exemplary form of the present disclosure, the method may further include controlling, by the controller, the emergency lamp system to turn on or turn off an emergency lamp provided in the electric vehicle.

According to an exemplary form of the present disclosure, the method may further include controlling, by the controller, the door system to unlock a door provided in the electric vehicle.

According to an exemplary form of the present disclosure, the method may further include controlling, by the controller, the electric seat system to move rearward an electric seat provided in the electric vehicle.

According to an exemplary form of the present disclosure, the method may further include controlling, by the controller, the emergency call system to call an emergency rescue team.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating a configuration of an apparatus for supporting safety of a driver, according to an exemplary form of the present disclosure;

FIG. 2 is a flowchart illustrating a method for supporting safety of a driver, according to an exemplary form of the present disclosure;

FIG. 3 is a flowchart illustrating an operation of a sensor provided in an apparatus for supporting safety of a driver, according to another form of the present disclosure;

FIG. 4 is a flowchart illustrating an operation of a power manager internetworking with an apparatus for supporting safety of a driver, according to an exemplary form of the present disclosure; and

FIG. 5 is a block diagram illustrating a computing system to execute a method for supporting safety of a driver, according to an exemplary form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, some forms of the present disclosure will be described in detail with reference to the exemplary drawings. In adding the reference numerals to the components of each drawing, it should be noted that the identical or equivalent component is designated by the identical numeral even when they are displayed on other drawings. Further, in describing the form of the present disclosure, a detailed description of well-known features or functions will be ruled out in order not to unnecessarily obscure the gist of the present disclosure.

In addition, in the following description of components according to an exemplary form of the present disclosure, the terms ‘first’, ‘second’, ‘B’, ‘(a)’, and ‘(b)’ may be used. These terms are merely intended to distinguish one component from another component, and the terms do not limit the nature, sequence or order of the constituent components. In addition, unless otherwise defined, all terms used herein, including technical or scientific tams, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

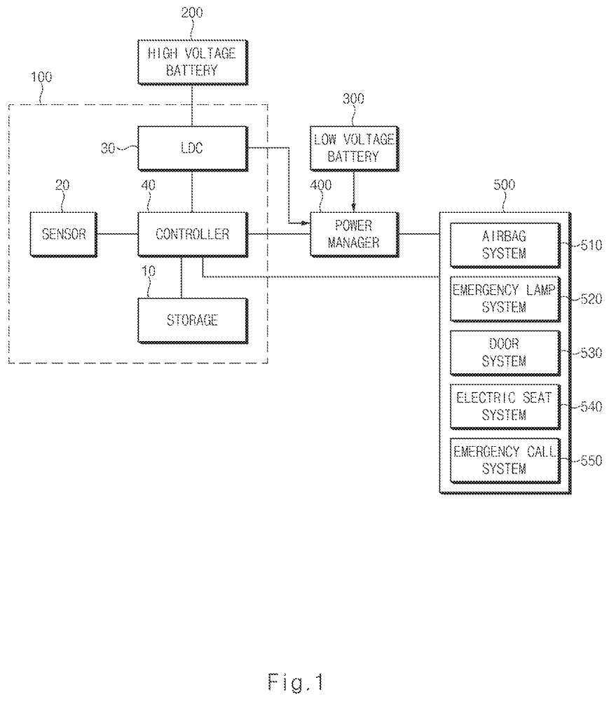

FIG. 1 is a block diagram illustrating a configuration of an apparatus for supporting safety of a driver, according to an exemplary form of the present disclosure.

As illustrated in FIG. 1, an apparatus 100 for supporting safety of a driver may include a storage 10, a sensor 20, a low voltage DC-DC converter (LDC) 30, and a controller 40. In some forms of the present disclosure, the components may be combined into each other to be implemented in one form, or some components may be omitted, depending on the manners of reproducing the apparatus 100 for supporting the safety of the driver.

In one form, an electric vehicle may include a high voltage battery 200 to supply driving power, a low voltage battery 300, a power manager 400 to supply power to a safety device 500, and the safety device 500. In this case, the safety device 500 may include various electric loads (electric devices) such as an airbag system 510, an emergency lamp system 520, a door system 530, an electric seat system 540, or an emergency lamp system 550. In this case, the power manager 400 is referred to as a “junction block”. When power is not supplied from the low voltage battery 300 (due to the failure of the low voltage battery 300 or a power cable disconnected), the power manager 400 may notify the controller 40 of that the power is not supplied. In addition, the power manager 400 may monitor a timeout state of a vehicle network to determine whether power supplied to the safety device 500 is cut off.

Regarding the above-described components, the storage 10 may store various logics, various algorithms, and various programs required in the process of controlling the LDC 30 to convert down the high voltage of the high voltage battery 200 to the low voltage (for example, 12 V) and to supply the low voltage to the power manager 400, in the state that power is not supplied to various safety devices 500 provided in the electric vehicle due to the collision accident, and of controlling the operation of the safety device 500.

The storage 10 may include at least one storage medium of a memory in a flash memory type, a hard disk type, a micro type, the type of a card (e.g., a Security Digital (SD) card or an eXtreme digital card), a Random Access Memory (RAM), a Static RAM (SRAM), a Read Only Memory (ROM), a Programmable ROM (PROM), an Electrically Erasable and Programmable ROM (EEPROM), a magnetic RAM (MRAM), a magnetic disk-type memory, or an optical disk-type memory.

The sensor 20, which is a sensor to sense the collision of the electric vehicle, may be implemented with, for example, a gravity acceleration sensor.

The LDC 30, which is a kind of a voltage converter, may convert down a high voltage of the high voltage battery 200 to a low voltage and may supply the low voltage to the power manager 400.

The controller 40 may perform the overall control such that the components normally perform the respective functions. In addition, the controller 40 may be implemented in the form of hardware or software, and may be implemented in the form of the combination of the hardware and the software. In one form, the controller 40 may be implemented with a micro-processor, but the present disclosure is not limited thereto.

In particular, the controller 40 may control the LDC 30 to convert down the high voltage of the high voltage battery 200 to the low voltage (for example, 12 V), and to supply the low voltage to the power manager 400, in the state that power is not supplied to various safety devices 500 provided in the electric vehicle due to the collision accident. In addition, the controller 40 may perform various control operations in the process of controlling the operation of the safety device 500.

The controller 40 may determine the collision of the electric vehicle through the sensor 20. In this case, the controller 40 may determine the collision of the electric vehicle through an airbag system provided in the electric vehicle.

The controller 40 may receive a signal for notifying a power cut-off, from the power manager 400. In this case, the signal for notifying the power cut-off is a signal for notifying that the power supplied from the low voltage battery 300 is cut off.

The controller 40 may control the LDC 30 to convert down the high voltage of the high voltage battery 200 to the low voltage (for example, 12 V) and to supply the low voltage to the power manager 400, regardless of whether the starting of the electric vehicle is completely prepared (start on/off). Then, the power manager 400 supplies power to various safety devices 500.

The controller 40 may control the emergency lamp system 520 to turn on/off an emergency lamp to notify the following vehicle of an accident.

The controller 40 may control the door system 530 to unlock a door to help the driver rapidly escape from an electric vehicle subject to the accident.

The controller 40 may control the electric seat system 540 to move rearward an electric seat to help the driver rapidly escape from the electric vehicle subject to the accident.

The controller 40 may control the emergency call system 550 to call an emergency rescue team.

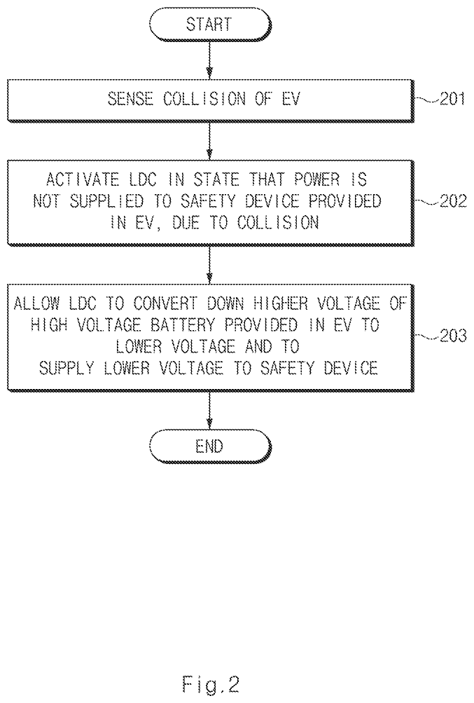

FIG. 2 is a flowchart illustrating a method for supporting safety of a driver, according to an exemplary form of the present disclosure.

First, the sensor 20 senses the collision of the electric vehicle (201).

Thereafter, the controller 40 activates the LDC 30, in the state that the power is not supplied to the safety device 500 provided in the electronic device due to the collision (202).

Thereafter, the LDC 30 converts down the high voltage of the high voltage battery 200, which is provided in the electric vehicle, to a low voltage and supplies the low voltage to the safety device 500 (203).

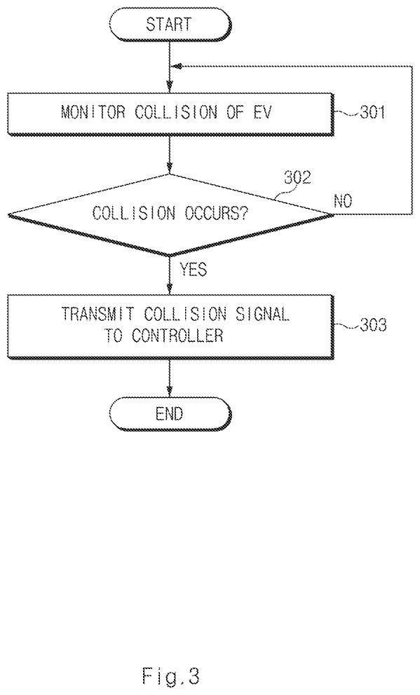

FIG. 3 is a flowchart illustrating an operation of a sensor provided in an apparatus for supporting safety of a driver, according to an exemplary form of the present disclosure.

First, the sensor 20 monitors whether the electric vehicle collides (301).

Thereafter, the sensor 20 transmits a collision signal to the controller, when collision occurs in the electric vehicle (302 and 303). In this case, the process of determining whether the collision occurs in the electric vehicle may be performed by the controller 40.

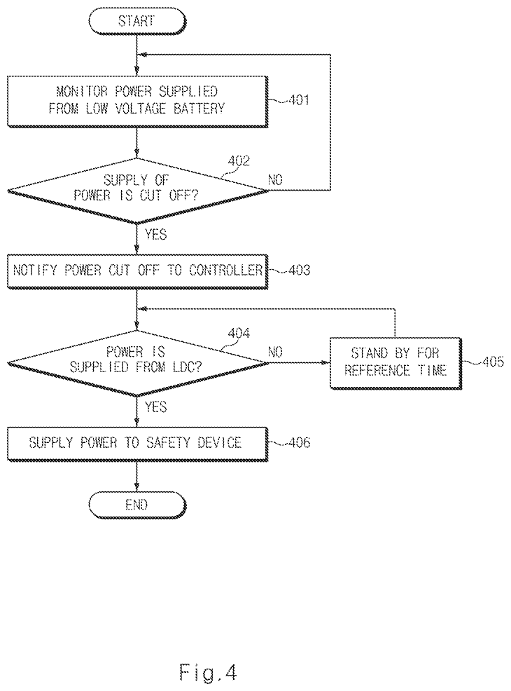

FIG. 4 is a flowchart illustrating an operation of a power manager internetworking with an apparatus for supporting safety of a driver, according to an exemplary form of the present disclosure.

First, the power manager 400 monitors power (a voltage) supplied from the low voltage battery 300 (401).

Thereafter, when the power supplied from the low voltage battery 300 is cut off (402), the power manager 400 notifies the power cut off to the controller 40 (403).

Thereafter, the power manager 400 determines whether power is supplied from LDC 30 (404).

When the power is not supplied from the LDC 30 as the determination result (404), the power manager 400 determines whether the power is supplied from the LDC 30 again after standby for a reference time (405).

When the power is supplied from the LDC 30 as the determination result (404), the power manager 400 supplies the power to the safety device 500 (406). When the power is supplied to the safety device 500, the airbag system 510 may deploy an airbag in secondary collision with the following vehicle (for example, a side-airbag is deployed in side collision), the emergency lamp system 520 may turn on or turn off an emergency lamp to warn a driver of the following vehicle, the door system 530 may unlock a door such that the driver rapidly escape from the vehicle, the electric seat system 540 may move rearward an electric seat such that the driver rapidly escape from the vehicle, and the emergency call system 550 may transmit an emergency call to an emergency rescue team, a police station, a fire station, or a telematics server, such that the driver may rapidly escape from the vehicle.

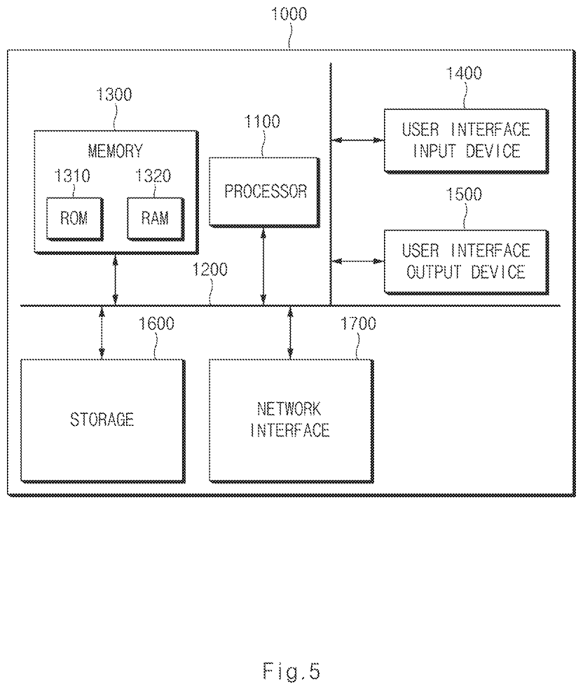

FIG. 5 is a block diagram illustrating a computing system to execute the method for supporting the safety of the driver, according to another form of the present disclosure.

Referring to FIG. 5, the method for supporting the safety of the driver may be implemented through the computing system. A computing system 1000 may include at least one processor 1100, a memory 1300, a user interface input device 1400, a user interface output device 1500, a storage 1600, and a network interface 1700, which are connected with each other via a system bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only ROM 1310 and a RAM 1320.

Thus, the operations of the methods or algorithms described in connection with the forms disclosed in the present disclosure may be directly implemented with a hardware module, a software module, or the combinations thereof, executed by the processor 1100. The software module may reside on a storage medium (i.e., the memory 1300 and/or the storage 1600), such as a RAM memory, a flash memory, a ROM, memory an erasable and programmable ROM (EPROM), an electrically EPROM (EEPROM), a register, a hard disc, a solid state drive (SSD), a removable disc, or a compact disc-ROM (CD-ROM). The exemplary storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as separate components of the user terminal.

As described above, according to an exemplary form of the present disclosure, in the apparatus and the method for supporting safety of the driver, the low voltage DC-DC converter (LDC) may be controlled to convert down the high voltage of the high voltage battery to the low voltage (for example, 12 V) and to supply the low voltage to the power manager, in the state that the power is not supplied to various safety devices provided in then electric vehicle due to the collision accident, and the operation of the safety device may be controlled, thereby supporting the escape of the driver while preparing for the secondary collision with the following vehicle.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary forms of the present disclosure are provided to explain the spirit and scope of the present disclosure, but not to limit them, so that the spirit and scope of the present disclosure is not limited by the forms. The scope of the present disclosure should be construed on the basis of the accompanying claims, and all the technical ideas within the scope equivalent to the claims should be included in the scope of the present disclosure.

What is claimed is:

1. An apparatus for supporting safety of a driver, the apparatus comprising:
a sensor configured to sense collision of an electric vehicle;
a voltage converter configured to:
convert down a high voltage of a high voltage battery to a low voltage, and
supply the low voltage to a safety device, wherein the high voltage battery and the safety device are provided in the electric vehicle; and
a controller configured to activate the voltage converter in a state that power is not supplied to the safety device due to the collision.

2. The apparatus of claim 1, wherein the controller is configured to:
receive a signal for notifying a power cut-off from a power manager provided in the electric vehicle.

3. The apparatus of claim 1, wherein the safety device includes:
at least one of an airbag system, an emergency lamp system, a door system, an electric seat system, or an emergency call system.

4. The apparatus of claim 3, wherein the controller is configured to:
control the emergency lamp system to turn on or turn off an emergency lamp provided in the electric vehicle.

5. The apparatus of claim 3, wherein the controller is configured to:
control the door system to unlock a door provided in the electric vehicle.

6. The apparatus of claim 3, wherein the controller is configured to:
control the electric seat system to move an electric seat of the electric vehicle rearward.

7. The apparatus of claim 3, wherein the controller is configured to:
control the emergency call system to call an emergency rescue team.

8. The apparatus of claim 1, wherein the sensor is a gravity acceleration sensor.

9. The apparatus of claim 1, wherein the voltage converter is a low voltage DC-DC converter (LDC).

10. A method for supporting safety of a driver, the method comprising:
sensing, by a sensor, collision of an electric vehicle;
activating, by a controller, a voltage converter in a state that power is not supplied to a safety device provided in the electric vehicle due to the collision; and
converting down, by the voltage converter, a high voltage of a high voltage battery of the electric vehicle to a low voltage and supplying the low voltage to the safety device.

11. The method of claim 10, wherein activating the voltage converter includes:
receiving a signal for notifying a power cut-off from a power manager provided in the electric vehicle.

12. The method of claim 10, wherein the safety device includes:
at least one of an airbag system, an emergency lamp system, a door system, an electric seat system, or an emergency call system.

13. The method of claim 12, further comprising:
controlling, by the controller, the emergency lamp system to turn on or turn off an emergency lamp provided in the electric vehicle.

14. The method of claim 12, further comprising:
controlling, by the controller, the door system to unlock a door provided in the electric vehicle.

15. The method of claim 12, further comprising:
controlling, by the controller, the electric seat system to move an electric seat of the electric vehicle rearward.

16. The method of claim 12, further comprising:
controlling, by the controller, the emergency call system to call an emergency rescue team.

17. The method of claim 10, wherein the sensor is a gravity acceleration sensor.

18. The method of claim 10, wherein the voltage converter is a low voltage DC-DC converter (LDC).
